(19) United States
(12) Patent Application Publication
(10) Pub. No.: US 2009/0227333 A1
(43) Pub. Date: Sep. 10, 2009

(54) GAMING MACHINE THAT REARRANGES SYMBOLS BASED ON REARRANGEMENT PATTERN DATA

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/234,008

(22) Filed: Sep. 19, 2008

Related U.S. Application Data
(60) Provisional application No. 61/033,947, filed on Mar. 5, 2008.

(51) Int. Cl. A63F 9/24; A63F 13/00

(52) U.S. Cl. 463/20

(57) ABSTRACT

A gaming machine 13 that determines symbols to be rearranged on a liquid crystal display 30 corresponding to a random number generated, extracts from ROM 108 rearrangement pattern data corresponding to the number of identical symbols when at least a predetermined number of the identical symbols are rearranged, rearranges symbols based on the extracted rearrangement pattern data, and provides an award corresponding to the identical symbols of which at least the predetermined number are rearranged.

### CROSS REFERENCE TO RELATED APPLICATIONS

This application claims benefit of U.S. Provisional Application No. 61/033,947, filed Mar. 5, 2008, the entire contents of which are incorporated herein by reference.

### BACKGROUND OF THE INVENTION

1. Field of the Invention

The present invention relates to a gaming machine that rearranges symbols based on rearrangement pattern data.

2. Related Art

Conventionally, in slot machines, a game is started when a player bets a certain amount of credits. Then, a plurality of reels on which a plurality of symbols are depicted start to rotate, and are stopped after a predetermined time elapses. As a result, a certain award is provided to the player based on a symbol combination which is displayed statically. U.S. Pat. No. 6,517,433 discloses a slot machine in which the order of reels to be stopped is determined in advance when rearranging symbols.

However, if the rotation of the reels is stopped in the order determined in advance, the order of symbols to be rearranged cannot be changed variably, which makes games monotonous.

The present invention provides a gaming machine with novel entertainment properties, which enhances a players' interest with processing of symbol rearrangement by offering a plurality of patterns for the order in which symbols are rearranged.

### SUMMARY OF THE INVENTION

In an aspect of the present invention, a gaming machine is provided, which includes: a display for variably displaying each of a plurality of symbol groups; memory for storing rearrangement pattern data for symbol rearrangement; and a controller executing the following operations of: (a) generating a random number and starting a game; (b) determining a symbol to be rearranged on the display corresponding to the generated random number; (c) variably displaying each of the plurality of symbol groups on the display; (d) when at least a predetermined number of identical symbols are determined to be rearranged, extracting rearrangement pattern data corresponding to the number of the identical symbols from the memory; (e) rearranging symbols based on the extracted rearrangement pattern data; and (f) providing an award corresponding to the identical symbols of which at least the predetermined number are rearranged.

In another aspect of the present invention, a gaming machine is provided, which includes: a display for variably displaying each of a plurality of symbol groups; memory for storing rearrangement pattern data for symbol rearrangement; and a controller executing the following operations of: (a) generating a random number and starting a game; (b) determining a symbol to be rearranged on the display corresponding to the generated random number; (c) variably displaying each of the plurality of symbol groups on the display; (d) when at least a predetermined number of identical symbols are determined to be rearranged, extracting rearrangement pattern data corresponding to the number of the identical symbols from the memory; (e) after rearranging symbols other than the identical symbols, rearranging the identical symbols based on the extracted rearrangement pattern data; and (f) providing an award corresponding to the identical symbols of which at least the predetermined number are rearranged.

In still another aspect of the present invention, a gaming machine is provided, which includes: a display for variably displaying each of a plurality of symbol groups; memory for storing rearrangement pattern data for symbol rearrangement; and a controller executing the following operations of: (a) generating a random number and starting a game; (b) determining a symbol to be rearranged on the display corresponding to the generated random number; (c) variably displaying each of the plurality of symbol groups on the display; (d) when at least a predetermined number of identical symbols are determined to be rearranged and a multiplication factor symbol representing a multiplication factor of an award to be provided is determined to be rearranged, extracting rearrangement pattern data corresponding to the number of the identical symbols from the memory; (e) rearranging symbols based on the extracted rearrangement pattern data so that the multiplication factor symbol is rearranged last; and (f) providing an award corresponding to the identical symbols of which at least the predetermined number and the multiplication factor symbol are rearranged.

In yet another aspect of the present invention, a gaming machine is provided, which includes: a display for variably displaying each of a plurality of symbol groups; memory for storing rearrangement pattern data for symbol rearrangement; and a controller executing the following operations of: (a) generating a random number and starting a game; (b) determining a symbol to be rearranged on the display corresponding to the generated random number; (c) variably displaying each of the plurality of symbol groups on the display; (d) when at least a predetermined number of identical symbols are determined to be rearranged and a multiplication factor symbol representing a multiplication factor of an award to be provided is determined to be rearranged, extracting rearrangement pattern data corresponding to the number of the identical symbols from the memory; (e) after rearranging symbols other than the identical symbols, rearranging symbols based on the extracted rearrangement pattern data, and further rearranging symbols so that the multiplication factor symbol is rearranged last; and (f) providing an award corresponding to the identical symbols of which at least the predetermined number and the multiplication factor symbol are rearranged.

In a further aspect of the present invention, a gaming machine is provided, which includes: a display for displaying each block arranged in the form of a matrix for displaying a plurality of symbols; an input device for allowing a player to start a game; and a controller for rearranging each symbol in each block arranged in the form of a matrix displayed on the display upon input to the input device, wherein the controller executes the following operations of: (a) determining symbols to be rearranged in each of the plurality of blocks by way of input to the input device; (b) when the number of identical symbols targeted for provision of an award are included among a plurality of symbols to be rearranged in all of the plurality of blocks, replacing the number of identical symbols, which are targeted for provision of an award, to be rearranged in each of the blocks with symbols to be rearranged in other blocks; and (c) providing an award after rearranging the number of identical symbols targeted for the award in all of the plurality of blocks.

### BRIEF DESCRIPTION OF THE DRAWINGS

FIG. 1 is a flowchart showing processing in a game executed in a gaming machine according to an embodiment of the present invention;

FIG. 2 is a perspective view showing the appearance of the gaming machine according to the embodiment of the present invention;

FIG. 3 is an enlarged front view showing a display area of the gaming machine according to the embodiment of the present invention;

FIG. 4 is a block diagram of a controller of the gaming machine according to the embodiment of the present invention;

FIG. 5 is a block diagram of a display/input controller of the gaming machine according to the embodiment of the present invention;

FIG. 6 is a flowchart showing a basic game processing executed in the gaming machine according to the embodiment of the present invention;

FIG. 7 is a flowchart of rearrangement processing executed in the gaming machine according to the embodiment of the present invention;

FIG. 8 is a rearrangement pattern data table according to the embodiment of the present invention;

FIG. 9 shows symbols to be rearranged in each of a plurality of symbol display regions in the gaming machine according to the embodiment of the present invention; and

FIGS. 10 to 15 are examples of display screens displaying rendered effects executed in the gaming machine according to the embodiment of the present invention.

### DETAILED DESCRIPTION OF THE INVENTION

An embodiment of the present invention is described below with reference to the accompanying drawings.

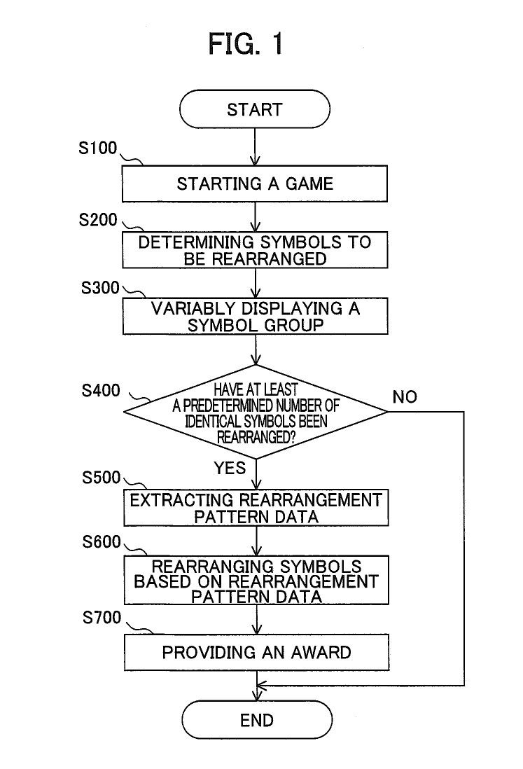

As shown in FIG. 1, CPU 106 starts a game (Step S100), determines symbols to be rearranged (Step S200), and variably displays a symbol group (Step S300). Next, the CPU 106 determines whether at least a predetermined number of identical symbols is rearranged (Step S400), extracts rearrangement pattern data when at least a predetermined number of identical symbols is rearranged (Step S500), rearranges symbols based on the extracted rearrangement pattern data (Step S600), and provides an award corresponding to the identical symbols of which at least the predetermined number are rearranged (Step S700).

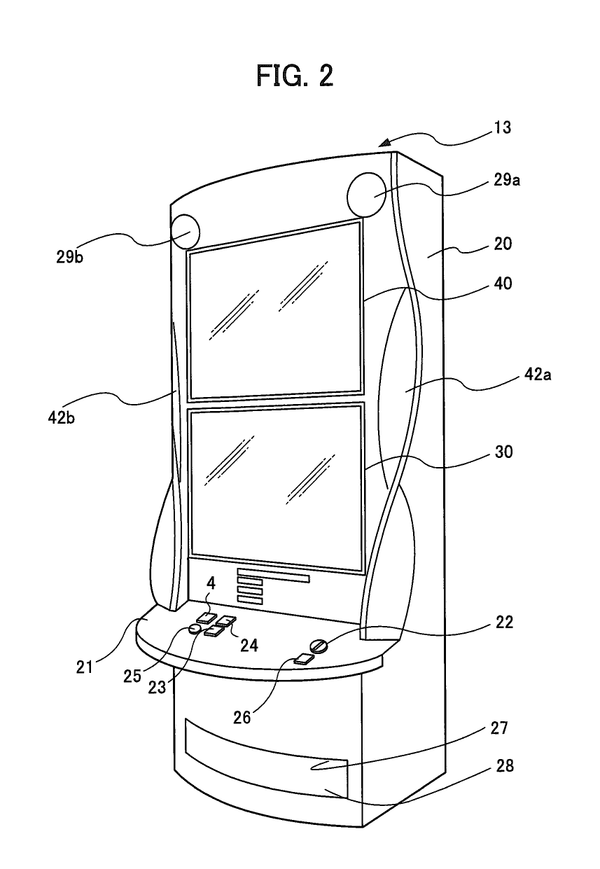

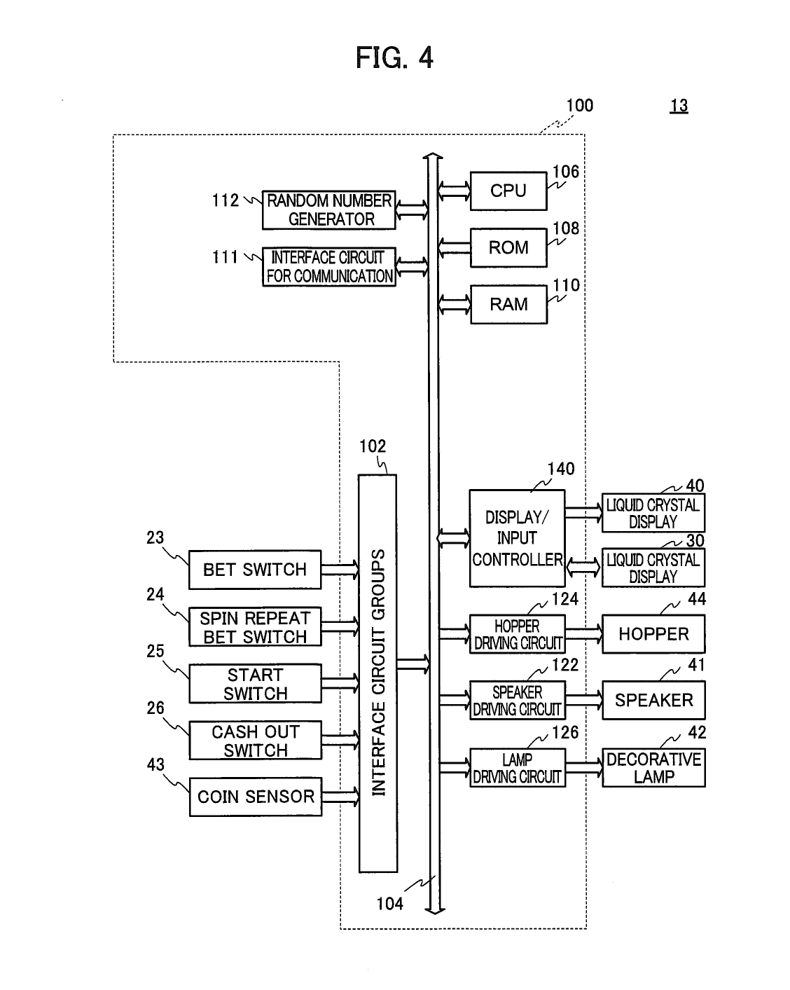

FIG. 2 is a perspective view showing the gaming machine 13 according to an embodiment of the present invention. The gaming machine 13 includes a cabinet 20. The cabinet 20 has a structure in which the face facing the player is open. The cabinet 20 contains various components including a game controller 100 (refer to FIG. 4) for electrically controlling the gaming machine 13, and a hopper 44 (refer to FIG. 4) for controlling the insertion, storage, and payout of coins (game medium), and the like. The game medium is not restricted to coins. In addition, examples of such game media include medals, tokens, electronic money or electronic value information (credits) having the same value.

The liquid crystal display 30 is installed substantially in the middle of the front face of the cabinet 20, and the liquid crystal display 40 is installed in an upper side of the cabinet 20.

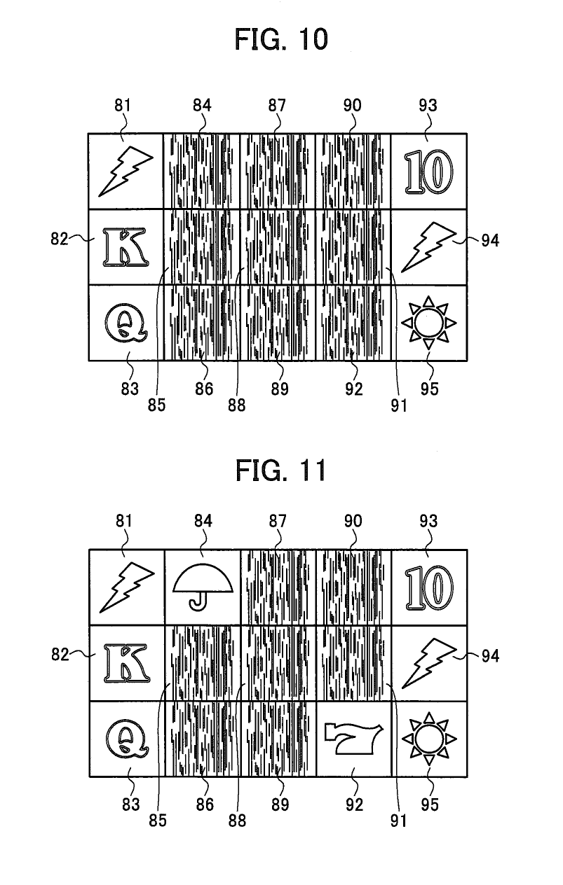

The liquid crystal display 30 realizes a display device for displaying a variety of images related to the game including rendered images and the like. Such a configuration allows the player to advance the game while visually confirming various kinds of images displayed on the aforementioned liquid crystal display 30. In such a game, the liquid crystal display 30 displays slot games shown in FIGS. 10 to 15 which are described later.

The gaming machine 13 includes video reels (a group of symbol images) and can display fifteen virtual reels on the liquid crystal display 30. It should be noted that the term “video reel” as used here represents a mechanism for displaying a reel on the liquid crystal display 30 in the form of an image.

The other liquid crystal display 40 above the liquid crystal display 30 is a display functioning as a sub display for displaying the rules of the game, demonstration screens, and the like.

Sound transmission openings 29a and 29b, through which sound effects emitted from a speaker 41 (refer to FIG. 4) contained inside the cabinet 20 are propagated outside the cabinet 20, are disposed on the upper right and left sides of the liquid crystal display 40, respectively. The sound transmission openings 29a and 29b generate sound effects and the like in accordance with the progress of the game. In addition, decorative lamps 42a and 42b are disposed on the right and left sides substantially in the middle of the gaming machine 13, respectively. The decorative lamps 42a and 42b emit light in accordance with the progress of the game.

The gaming machine 13 includes a substantially horizontal operation portion 21 below the liquid crystal display 30. Disposed on the right side of the operation portion 21 is a coin insertion slot 22 through which a number of coins are inserted into the gaming machine 13. On the other hand, the components provided to the left side of the operation portion 21 include: a BET switch 23 that allows the player to select the number of coins, which serves as a gaming medium to be bet; and a spin repeat bet switch 24 that allows the player to play another game without changing the number of coins bet in the previous game. Such an arrangement allows the player to set the number of coins to be bet by performing a pushing operation on either the BET switch 23 or the spin repeat bet switch 24.

In the operation portion 21, a start switch 25 for accepting for each game the player's operation for starting a game is disposed on the left side of the BET switch 23. Upon performing a pushing operation on either the start switch 25 or the spin repeat bet switch 24, which serves as a trigger to start the game, an image in which the aforementioned fifteen video reels start to rotate is displayed.

A cash out switch 26 is provided near the coin insertion opening 22 on the operation portion 21. Upon the player pushing the cash out switch 26, the inserted coins are paid out from a coin payout opening 27 provided at a lower portion of the front face. The coins thus paid out are retained in a coin tray 28.

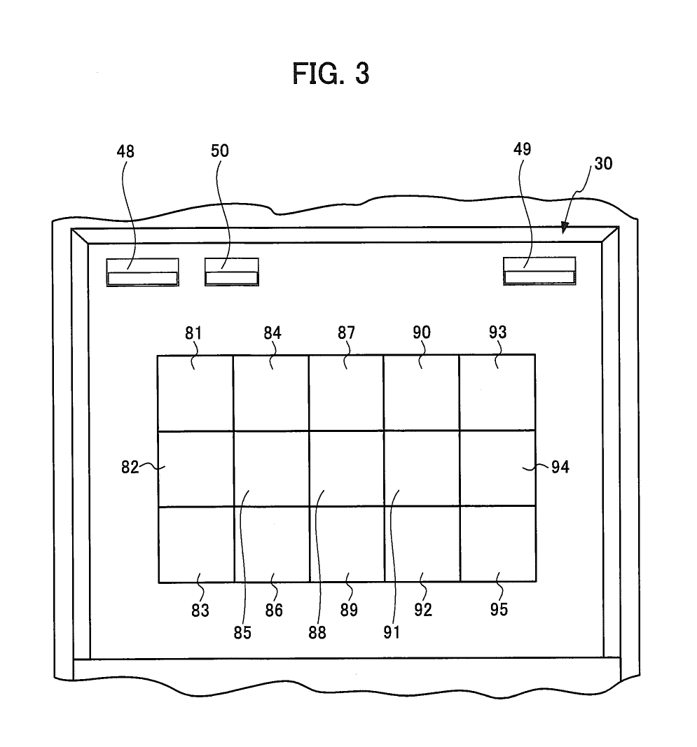

FIG. 3 is an enlarged view showing the display region of the gaming machine 13. As shown in FIG. 3, the gaming machine 13 has symbol display regions 81 to 95 arranged in the form of a matrix with 3 rows×5 columns. The symbol display regions are also called as symbol display blocks or symbol display locations. The abovementioned fifteen video reels are arranged at each of the symbol display regions 81 to 95, respectively.

The game available in the present embodiment is a game in which an award is provided to a player corresponding to the number of identical symbols rearranged in the symbol display regions 81 to 95. The number of identical symbols targeted for provision of awards can be defined arbitrarily such as three or more symbols, or the like.

It is arranged so that a payout number display portion 48, a bet number display portion 50, and a credit number display portion 49 can be displayed in this order from the left side on the upper portion of the liquid crystal display 30. The payout display portion 48 is something for displaying the amount of the coins paid out when no less than a predetermined number of identical symbols for providing an award are rearranged and displayed on the symbol display regions 81 to 95. The credit number display portion 49 displays the credit number of coins stored in the gaming machine 13. The bet amount display portion 50 is a component for displaying the bet amount, which is the number of coins bet.

FIG. 4 is a block diagram showing the electrical configuration of the game controller 100 of the gaming machine 13. As shown in FIG. 4, the game controller 100 of the gaming machine 13 is a microcomputer and provided with an interface circuit group 102, an input-output bus 104, a CPU 106, a ROM 108, a RAM 110, an interface circuit 111 for communication, a random number generator 112, a speaker drive circuit 122, a hopper drive circuit 124, a lamp drive circuit 126, and a display/input controller 140.

The interface circuit groups 102 are electrically connected with the input/output bus 104, which carries out input and output of data signals or address signals for the CPU 106.

The start switch 25 is electrically connected with the interface circuit groups 102. In the interface circuit groups 102, a start signal generated by the start switch 25 is converted into a predetermined form of signal to be supplied to the input/output bus 104.

Furthermore, the BET switch 23, the spin repeat bet switch 24, and the cash out switch 26 are also connected to the interface circuit groups 102. Each of the switching signals output from these switches 23, 24, and 26 is also supplied to the interface circuit groups 102, and is converted into a predetermined signal by the interface circuit groups 102. The switching signals thus converted are supplied to the input/output bus 104.

A coin sensor 43 is also electrically connected to the interface circuit groups 102. The coin sensor 43 detects coins inserted into the coin insertion slot 22, and is disposed at an appropriate position relative to the coin insertion slot 22. The sensing signal output from the coin sensor 43 is also supplied to the interface circuit groups 102, and is converted into a predetermined signal by the interface circuit groups 102. The sensing signal thus converted is supplied to the input/output bus 104.

The ROM 108 and the RAM 110 are connected to the input/output bus 104.

Upon acceptance of the start operation of a game through the start switch 25, the CPU 106 reads a game program to execute the game. The game program is programmed as follows. That is, a display for starting the scrolling of the symbols on the fifteen video reels is made on the liquid crystal display 30 via the display/input controller 140. Thereafter, a display for stopping the fifteen video reels is made to rearrange the fifteen video reels. In a case where at least a predetermined number of identical symbols among all of the symbols which are stopped in each reel are rearranged and displayed, coins corresponding to the number of identical symbols rearranged and displayed are paid out.

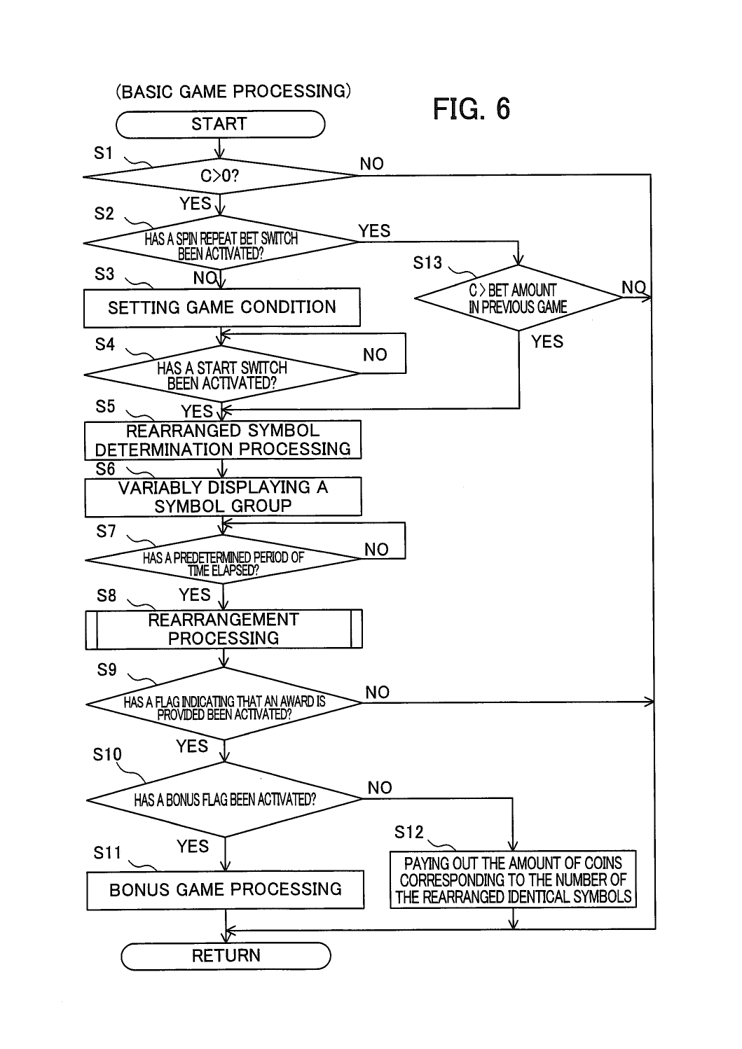

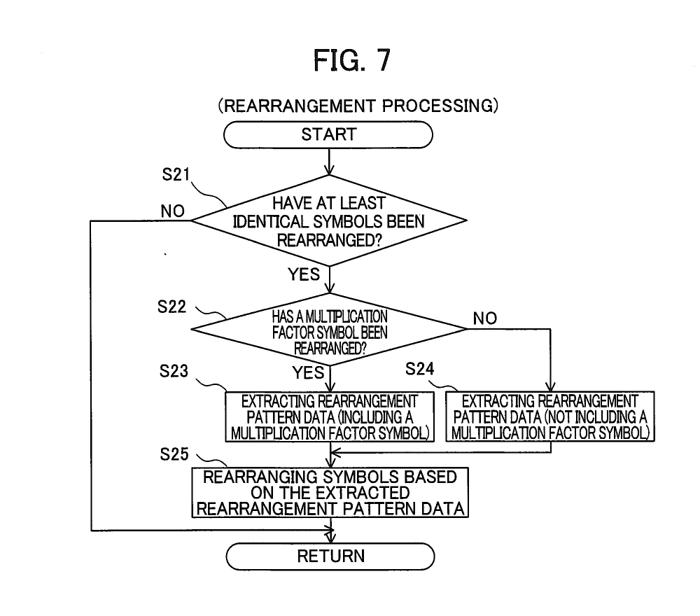

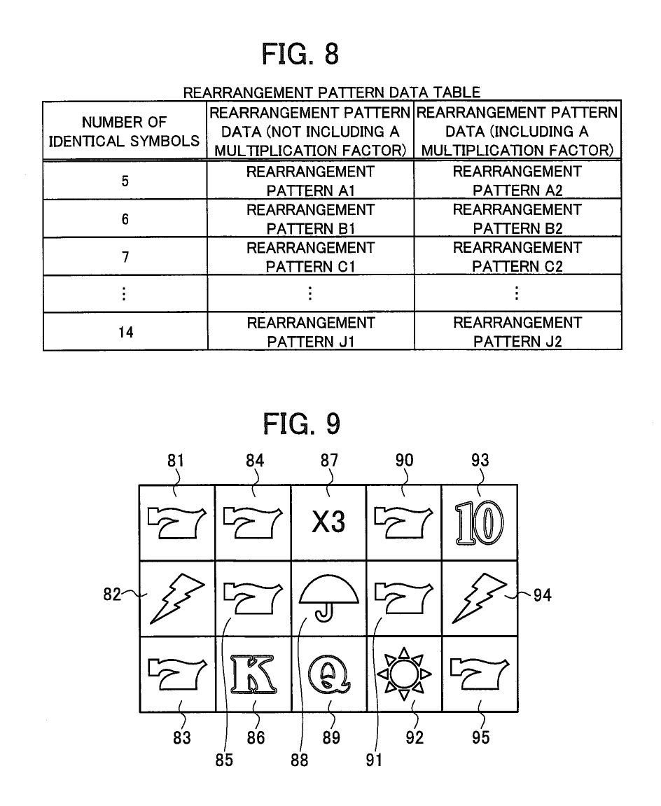

The ROM 108 stores a control program for governing and controlling the gaming machine 13, a program for executing routines as shown in FIGS. 6 and 7 (hereinafter referred to as a “routine execution program”), and initial data for executing the control program, and various data tables used in determination processes. The routine execution program includes the abovementioned game program. The table shown in FIG. 8 and the like are examples of the data tables described above. The RAM 110 temporarily stores flags, variables, etc., used for the aforementioned control program.

The game program includes a rearranged symbol determination program. The aforementioned rearranged symbol determination program is used for determining 15 symbols rearranged on the symbol display regions 81 to 95. The aforementioned rearranged symbol determination program includes symbol weighing data that corresponds to each of multiple types of payout rates (e.g., 80%, 84%, and 88%). The symbol weighing data is data for each of the fifteen video reels, and indicates the corresponding relationship between each symbol and one or multiple random numbers in a predetermined number range (0 to 65535). The payout rate is determined based upon the payout rate setting data stored in the ROM 108. The determination of rearranged symbols is performed based upon the symbol weighing data that corresponds to the payout rate.

Furthermore, a communication interface circuit 111 is connected to the input/output bus 104. The communication interface circuit 111 is a circuit for communicating with the central controller 11, etc. via the network including various types of networks such as a LAN.

The random number generator 112 for generating a random number is connected to the input/output bus 104. The random number generator 112 generates random numbers in a predetermined range of “0” to “65535” (the sixteenth power of two minus one), for example. Alternatively, an arrangement may be made in which the CPU 106 generates a random number by computation.

The speaker driving circuit 122 for the speakers 41 is also electrically connected with the input/output bus 104. The CPU 106 reads the sound data stored in the ROM 108, and transmits the sound data thus read to the speaker driving circuit 122 via the input/output bus 104. In this way, the speakers 41 generate predetermined sound effects.

The hopper driving circuit 124 for driving the hopper 44 is also electrically connected to the input/output bus 104. Upon receiving a cash out signal input from the cash out switch 26, the CPU 106 transmits a driving signal to the hopper driving circuit 124 via the input/output bus 104. Accordingly, the hopper 44 pays out coins such that the amount thereof is equivalent to the current number of coins remaining as credits, which is stored in a predetermined memory area of the RAM 110.

Alternatively, the payout of the coins may be performed in a mode of storing credit data in a data card or the like, instead of using physical coins. That is, the player may carry a card functioning as a recording medium, and store the data related to the credit by inserting the card into the gaming machine 13.

The lamp driving circuit 126 for driving the decorative lamps 42a and 42b is also connected to the input/output bus 104. The CPU 106 transmits the signal for driving the lamps according to the predetermined conditions based on the program stored in the ROM 108 to the lamp driving circuit 126. Thus, decorative lamps 42a and 42b blink and the like.

The display/input controller 140 is connected to the input/output controller 104. The CPU 106 creates an image display command corresponding to the state and results of the game, and outputs the image display command thus created to the display/input controller 140 via the input/output bus 104. Upon receiving the image display command input from the CPU 106, the display/input controller 140 creates a driving signal for driving the liquid crystal display 30 and the liquid crystal display 40 according to the image display command thus input, and outputs the driving signal thus created to the liquid crystal display 30 and the liquid crystal display 40. As a result, a predetermined image is displayed on the liquid crystal display 30 and the liquid crystal display 40. The display/input controller 140 transmits the signal input through the touch panel 32 provided on the liquid crystal display 30 to the CPU 106 via the input/output bus 104 in the form of an input signal. In addition, the image display command includes commands corresponding to a payout number display portion 48, a credit number display portion 49, and a bet number display portion 50.

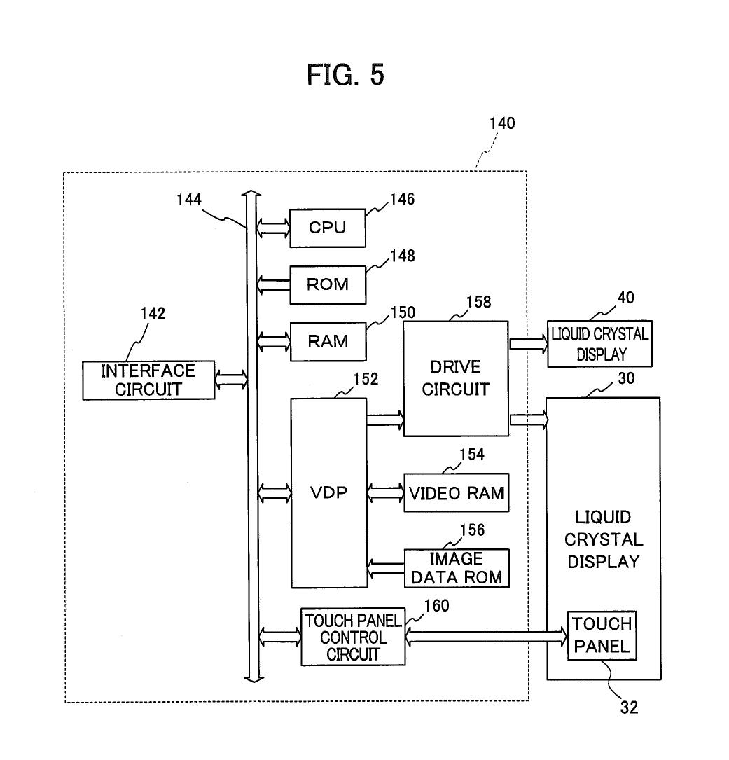

FIG. 5 is a block diagram showing the electrical configuration of the display/input controller 140 of the gaming machine 13. The display/input controller 140 of the gaming machine 13 is a sub-micro computer which performs image display processing and the control of input from the touch panel 32, and which has an interface circuit 142, an input/output bus 144, CPU 146, ROM 148, RAM 150, VDP 152, video RAM 154, ROM 156 for image data, a drive circuit 158, and a touch panel control circuit 160.

The interface circuit 142 is connected to the input/output bus 144. An image display instruction outputted from the CPU 106 on the abovementioned game controller 100 is supplied to the input/output bus 144 via the interface circuit 142. The input/output bus 144 performs input/output of data signals or address signals to and from the CPU 146.

The ROM 148 and the RAM 150 are connected to the input/output bus 144. The ROM 148 stores a display control program under which a drive signal to be supplied to the liquid crystal display 30 and the liquid crystal display 40 is generated based on the image display instruction from the CPU 106 on the game controller 100. On the other hand, the RAM 150 stores flags and variables used in the aforementioned display control program.

The VDP 152 is connected to the input/output bus 144. The VDP 152 includes a so-called sprite circuit, a screen circuit, a palette circuit, etc., and can perform various types of processing for displaying images on the liquid crystal display 30 and the liquid crystal display 40. The video RAM 154 and the ROM 156 are connected to the VDP 152. The video RAM 154 stores image data based on the image display instructions from the CPU 106 on the game controller 100. The ROM 156 for image data stores various kinds of image data containing the abovementioned produced image data. Furthermore, the driving circuit 158 for outputting a driving signal for driving the liquid crystal display 30 and the liquid crystal display 40 is connected to the VDP 152.

By reading and executing the display control program stored in the ROM 148, the CPU 146 instructs the video RAM 154 to store image data to be displayed on the liquid crystal display 30 and the liquid crystal display 40 in response to the image display instruction from the CPU 106 on the game controller 100. Examples of the image display commands include various kinds of image display commands including the aforementioned image display commands for visual effects, etc.

The image data ROM 156 stores various kinds of image data including the aforementioned image data for visual effects, etc.

The touch panel control circuit 160 transmits the signals input via the touch panel 32 provided on the liquid crystal display 30 to the CPU 106 via the input/output bus 144 in the form of an input signal.

FIG. 6 is a flowchart showing the flow of the processing operation of a basic game of the gaming machine 13, which is executed by the game controller 100 of the gaming machine 13. The routine of FIG. 6 is a unit game.

Supposing that the gaming machine 13 is activated in advance and the variables used in the CPU 106 on the game controller 100 are initialized to predetermined values, respectively, thereby providing normal action of the gaming machine 13.

Firstly, the CPU 106 on the game controller 100 determines whether any credits remain, which correspond to the remaining amount of coins inserted by the player (Step S1). More specifically, CPU 106 reads the amount of credits C stored in the RAM 110, and executes processing according to the amount of credits C. When the amount of credits C equals “0” (NO in Step S1), the CPU 106 terminates the routine without executing any processing, since it cannot start a game. When the amount of credits C is at least “1” (YES in Step S1), the CPU 106 determines that coins remain as credits, and the CPU 106 advances the processing to Step S2.

In Step S2, CPU 106 determines whether or not a pushing operation has been applied to the spin bet repeat switch 24. When the spin repeat bet switch 24 has been pushed and the CPU 106 receives an operation signal from the spin repeat bet switch 24 (YES in Step S2), the CPU 106 advances the processing to Step S13. On the other hand, when the CPU 106 does not receive the operation signal from the switch 24 after a predetermined period of time has elapsed (NO in Step S2), the CPU 106 determines that the switch 24 has not been pressed and advances the processing to Step S3.

In the following Step S3, the CPU 106 sets the game conditions. More specifically, the CPU 106 determines the number of coins bet in a unit game based on the operation of the BET switch 23. The CPU 106 receives the operation signals generated by the player operating the BET switch 23. Then, the CPU 106 stores the bet amount in a predetermined memory area of the RAM 110 based on the number of times the operation signals have been received. The CPU 106 reads the amount of credits C stored in a predetermined memory area of the RAM 110, and subtracts the abovementioned bet amount from the amount of credits C thus read. Then, the CPU 106 stores the subtracted value in a predetermined memory area of the RAM 110. Subsequently, the CPU 106 advances the processing to Step S4.

In the following Step S4, the CPU 106 determines whether the start switch 25 is ON, and then waits for the start switch 35 to be operated. Upon the start switch 25 being operated, and accordingly, upon the operation signal being input from the start switch 25 (in a case of “YES” in the determination processing in Step S4), the CPU 106 determines that the start switch 25 has been operated, and the processing advances to Step S5.

On the other hand, in Step S13, the CPU 106 determines whether the amount of credits C is at least the total bet number in a previous game. In other words, the CPU 106 determines whether it can start a game in response to a pressing operation applied to the spin repeat bet switch 24. More specifically, when the spin repeat bet switch 24 has been pushed, and the operation signal has been inputted to the CPU 106 from the spin repeat bet switch 24, the CPU 106 reads the credit amount C and the bet amount bet in the previous game, which are stored in RAM 110. Then, the CPU 106 determines whether or not the credit amount C is equal to or greater than the bet amount bet in the previous game based upon the relation between the credit amount C thus read and the bet amounts. The CPU 106 performs processing based upon the determination results. When the CPU 106 determines that the amount of credits C is less than the bet amount (NO in Step S13), the CPU 106 terminates the present routine without any processing, since it cannot start a game. On the other hand, in a case where determination has been made that the aforementioned amount of credits C is at least the bet amount bet in the previous game (in a case of “YES” in Step S13), the CPU 106 subtracts the bet amount bet in the previous game from the aforementioned amount of credits C, and stores the subtracted value in a predetermined area of the RAM 110. Subsequently, the CPU 106 advances the processing to Step S5.

In the following Step S5, the CPU 106 performs rearranged symbol determination processing. A specific description is made below regarding the rearranged symbol determination processing.

Firstly, the CPU 106 selects a random number in a range of values from 0 to 65535 for each of the fifteen reels by extracting a random number from the random generator 112. Next, the CPU 106 reads payout rate setting data from the ROM 108 to store in the RAM 110, refers to symbol weighing data corresponding to the payout rate setting data, and determines symbols to be rearranged in the symbol display regions 81 to 95 based on the fifteen random number values thus selected. The CPU 106 determines symbols to be rearranged in the symbol display regions 81 to 95, thereby determining a winning combination. In the present embodiment, in a case where five or more identical symbols are rearranged on the symbol display regions 81 to 95, a winning combination corresponding to the rearranged symbol is achieved.

Upon determining a rearranged symbol, the CPU 106 determines whether at least a predetermined number of identical symbols (five symbols) for providing an award among 15 symbols to be rearranged are rearranged or not. In a case where at least a predetermined number of identical symbols (five symbols) for providing an award among 15 symbols to be rearranged are rearranged, the CPU 106 activates a flag indicating providing an award for generating an award corresponding to the predetermined number of identical symbols (five symbols) for providing an award. The activated flag, which indicates the player has won an award, is stored in a predetermined area of the RAM 110 according to the instruction from the CPU 106. On the other hand, in a case where at least a predetermined number of identical symbols (five symbols) for providing an award among 15 symbols to be rearranged are not rearranged (a losing combination), the CPU 106 does not activate the flag indicating providing the award. Subsequently, CPU 106 advances the processing to Step S6.

In the following Step S6, the CPU 106 instructs each of the fifteen video reels to start to rotate.

Upon displaying the image which shows the fifteen video reels starting to rotate, the CPU 106 waits for a predetermined period of time to elapse (Step S7). After the predetermined period of time has elapsed (in a case of “YES” in processing of Step S7), the CPU 106 instructs the fifteen video reels to stop rotating, thereby rearranging 15 symbols (Step S8). Subsequently, the CPU 106 advances the processing to Step S9. Free game processing is described below with reference to FIG. 7.

In the following Step S9, the CPU 106 determines whether the flag indicating that an award is provided, which is stored in a predetermined memory area in the RAM 110, is activated or not by means of the rearranged symbol determination processing in Step S5. In a case where the flag indicating that an award is provided is not activated (NO in the processing of Step S9), the CPU 106 terminates the present routine. On the other hand, in a case where the flag indicating that an award is provided is activated (YES in the processing of Step S9), the CPU 106 advances the processing to Step S10.

In the following Step S10, the CPU 106 determines whether the flag (a bonus flag) indicating switching to a bonus game, which is stored in a predetermined memory area in the RAM 110, is activated or not by the rearranged symbol determination processing in Step S5. More specifically, in a case where the flag indicating the switch to a bonus game is activated (YES in the processing of step S10), the CPU 106 advances the processing to step S11. On the other hand, in a case where the flag indicating the switch to a bonus game is not activated (NO in the processing of step S10), the CPU 106 advances the processing to step S12.

In the following Step S11, the CPU 106 performs bonus game processing. More specifically, the CPU 106 starts a bonus game and performs a predetermined number of the bonus games. Subsequently, the CPU 106 terminates the present routine.

In the following Step S12, the CPU 106 pays out the amount of coins corresponding to the number of the rearranged identical symbols, which are at least a predetermined number (five symbols). More specifically, the CPU 106 refers to a payout table (not shown) and calculates the amount of coins corresponding to the number of the rearranged identical symbols, which are at least a predetermined number (five symbols). In a case where a multiplication factor symbol for multiplying the amount of coins by a predetermined number is rearranged, the CPU 106 recalculates as a payout amount the number which is the amount of coins thus calculated multiplied by the number corresponding to the multiplication factor symbol. The CPU 106 reads the credit amount stored in the aforementioned predetermined memory area of the RAM 110. Then, the CPU 106 calculates the sum total amount of coins to be paid out thus calculated (recalculated) and the credit amount thus read, and stores the sum thus calculated in a predetermined memory area of the RAM 110. The CPU 106 displays the aforementioned value thus stored on the credit number display portion 49. Subsequently, the CPU 106 terminates the present routine.

Free game processing is described below with reference to FIG. 7.

In Step S21 of FIG. 7, the CPU 106 determines whether at least five identical symbols are rearranged or not. More specifically, the CPU 106 determines whether at least five identical symbols are rearranged in the symbol display regions 81 to 95. If this determination is YES, the processing is shifted to Step S22. If this determination is NO, the processing is shifted to Step S9 of FIG. 6.

In Step S22, the CPU 106 determines whether the multiplication factor symbol is rearranged or not. If this determination is YES, the processing is shifted to Step S23. If this determination is NO, the processing is shifted to Step S24.

In Step S23, the CPU 106 refers to a rearrangement pattern data table, which is described later in FIG. 8, and extracts rearrangement pattern data (including a multiplication factor symbol). In addition, the CPU 106 stores the extracted data in a predetermined area of the RAM 110. Then, the CPU 106 advances the processing to Step S25.

In Step S24, the CPU 106 refers to a rearrangement pattern data table, which is described later in FIG. 8, and extracts rearrangement pattern data (not including a multiplication factor symbol). In addition, the CPU 106 stores the extracted number in a predetermined memory area of the RAM 110. Then, the CPU 106 advances the processing to Step S25.

In Step S25, the CPU 106 performs rearranging of symbols based on the extracted rearrangement pattern data. The rearrangement processing is described with reference to FIGS. 9 to 15.

The rearrangement pattern data table is described with reference to FIG. 8. The CPU 106 refers to the rearrangement pattern data table when extracting rearrangement pattern data (not including a multiplication factor symbol) in Step S23 of FIG. 7 and when extracting rearrangement pattern data (including a multiplication factor symbol) in Step S24 of FIG. 7. For example, when the number of identical symbols to be rearranged is “5” and a multiplication factor symbol is rearranged, rearrangement pattern data (including a multiplication factor symbol) is determined to be “rearrangement pattern A2”, and then extracted.

FIG. 9 shows that symbols rearranged in Step S5 of FIG. 6 are internally determined as to where those symbols will be rearranged in the symbol display regions 81 to 95.

According to FIG. 9, it is internally determined that seven individual “7” symbols are rearranged in the symbol display regions 81, 83, 84, 85, 90, 91, and 95, respectively. In addition, it is internally determined that a multiplication factor symbol “×3” for recalculating the payout amount by multiplying by 3 is rearranged in the symbol display region 87. That is, since it is determined that seven individual “7” symbols and one multiplication factor symbol “×3” are rearranged, the rearrangement pattern data (including a multiplication factor symbol) is determined to be the “rearrangement pattern C2”, and then extracted.

In addition, when a multiplication factor is not rearranged, rearrangement pattern data is determined among rearrangement pattern data (not including a multiplication factor symbol), and then extracted.

FIGS. 10 to 15 show that symbols are rearranged in the symbol display regions 81 to 95, respectively, based on rearrangement pattern data “rearrangement pattern C2”. With reference to FIGS. 10 to 15, symbols “7” targeted for provision of an award are rearranged so as to be adjacent to a symbol display region 88 (the center symbol display region) after the other symbols are rearranged, and a multiplication factor symbol “×3” is rearranged last in the symbol display region 88.

Although not shown, when a multiplication factor symbol is not rearranged, symbols “7” targeted for provision of an award are rearranged so as to be adjacent to a symbol display region 88 (the center symbol display region) after the other symbols are rearranged, and a symbol “7”, which is rearranged last, is rearranged in the center symbol display region 88.

In FIG. 10, the symbols “7” have not been rearranged yet, and symbols that have already been rearranged in the symbol display regions 81 to 83 and 95 are different from those symbols determined to be rearranged in FIG. 9. This is because the other symbols to be rearranged are replaced so that symbols “7” targeted for provision of an award are rearranged so as to be adjacent to a symbol display region 88 (the center symbol display region) after the other symbols are rearranged. The CPU 106 performs the replacement processing for symbols to be rearranged in Step S25 of FIG. 7.

According to FIG. 10, a “Thunder” symbol, a “K” symbol, a “Q” symbol, a “10” symbol, a “Thunder” symbol, and a “Sun” symbol are rearranged in the symbol display regions 81 to 83 and 93 to 95, respectively. In addition, symbols in the other symbol display regions are being variably displayed, which indicates that the symbols have not been rearranged yet.

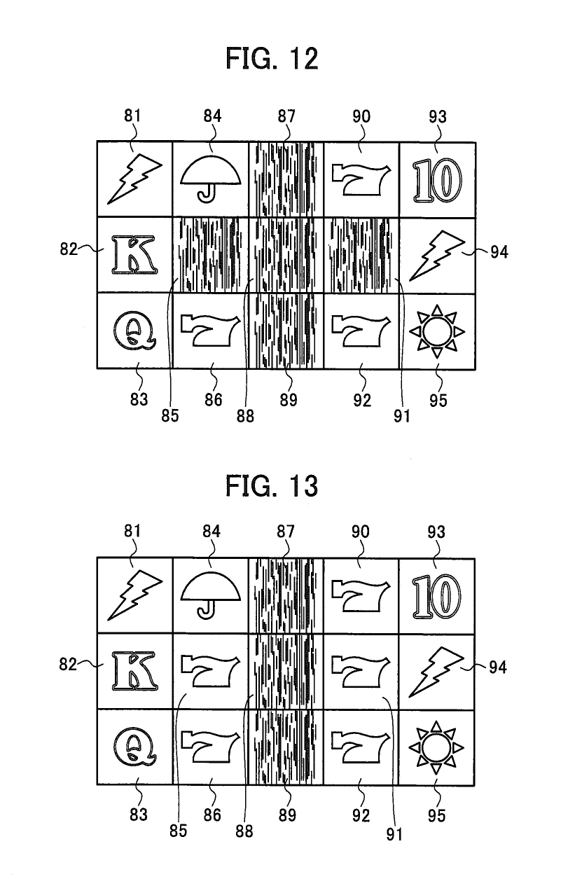

FIG. 11 shows that the remaining symbols as well as the symbols which have been rearranged in FIG. 10 are rearranged next. According to FIG. 11, an “Umbrella” symbol and a “7” symbol are rearranged in the symbol display regions 84 and 91, respectively. FIG. 12 shows that the remaining symbols, as well as the symbols which had been rearranged in FIG. 11, are rearranged next.

According to FIG. 12, “7” symbols are rearranged in the symbol display regions 86 and 90, respectively.

FIG. 13 shows that the remaining symbols, as well as the symbols which had been rearranged in FIG. 12, are rearranged next. According to FIG. 13, “7” symbols are rearranged in the symbol display regions 85 and 91, respectively.

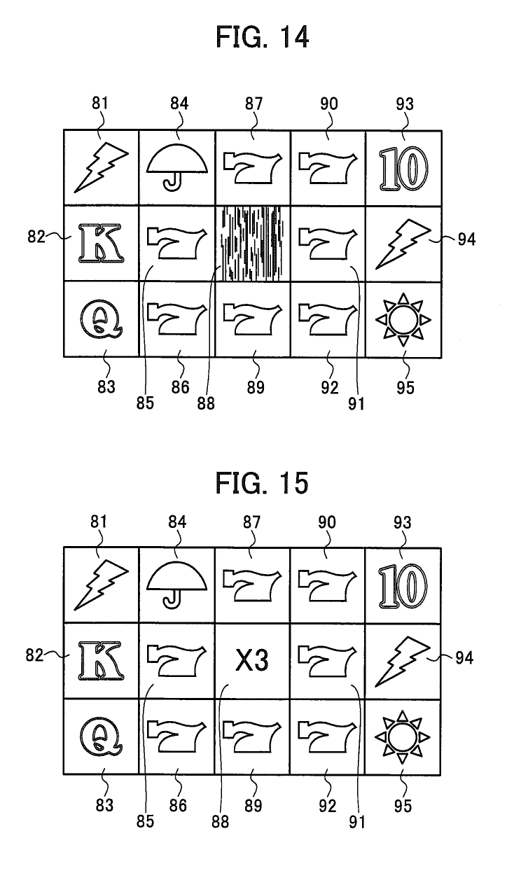

FIG. 14 shows that the remaining symbols, as well as the symbols which had been rearranged in FIG. 13, are rearranged next. According to FIG. 14, “7” symbols are rearranged in the symbol display regions 87 and 89, respectively.

FIG. 15 shows that the remaining symbols, as well as the symbols which had been rearranged in FIG. 14, are rearranged next. According to FIG. 15, a “×3” symbol is rearranged in the symbol display region 88.

Due to the symbol rearrangements shown in FIGS. 10 to 15, the player's interest can be enhanced regarding an appearance of a symbol targeted for provision of an award compared to a normal symbol rearrangement (once symbols are determined to be rearranged in the symbol display regions, the symbols are not changed and rearranged as is). In addition, the player not only has an interest as to whether a multiplication factor symbol appears or not, but also has a great interest regarding a resulting award in which the payout amount is multiplied corresponding to a multiplication factor symbol to appear.

While an embodiment of the gaming machine according to the present invention has been described, it is to be understood that the above description is intended to be illustrative, and not restrictive, and any changes in design may be made to specific configurations such as various means. Moreover, it should be understood that the advantages described in association with the embodiments are merely a listing of most preferred advantages, and that the advantages of the present invention are by no means restricted to those described in connection with the embodiments.

For example, although in the present embodiment, a rearrangement is made based on rearrangement pattern data during a basic game, the present invention is not limited thereto, and may be rearranged based on rearrangement pattern data during a bonus game.

In addition, although in the present embodiment, the example applied to a video reel slot machine is explained regarding the present invention, the present embodiment is not limited thereto, and for example, the present invention may be applied to a mechanical reel slot machine.

What is claimed is:

1. A gaming machine comprising:
a display for variably displaying each of a plurality of symbol groups;
memory for storing rearrangement pattern data for symbol rearrangement; and
a controller executing the following operations of:
(a) generating a random number and starting a game;
(b) determining a symbol to be rearranged on the display corresponding to the generated random number;
(c) variably displaying each of the plurality of symbol groups on the display;
(d) when at least a predetermined number of identical symbols are determined to be rearranged, extracting rearrangement pattern data corresponding to the number of the identical symbols from the memory;
(e) rearranging symbols based on the extracted rearrangement pattern data; and
(f) providing an award corresponding to the identical symbols of which at least the predetermined number are rearranged.

2. A gaming machine comprising:
a display for variably displaying each of a plurality of symbol groups;
memory for storing rearrangement pattern data for symbol rearrangement; and
a controller executing the following operations of:
(a) generating a random number and starting a game;
(b) determining a symbol to be rearranged on the display corresponding to the generated random number;
(c) variably displaying each of the plurality of symbol groups on the display;
(d) when at least a predetermined number of identical symbols are determined to be rearranged, extracting rearrangement pattern data corresponding to the number of the identical symbols from the memory;
(e) after rearranging symbols other than the identical symbols, rearranging the identical symbols based on the extracted rearrangement pattern data; and
(f) providing an award corresponding to the identical symbols of which at least the predetermined number are rearranged.

3. A gaming machine comprising:
a display for variably displaying each of a plurality of symbol groups;
memory for storing rearrangement pattern data for symbol rearrangement; and
a controller executing the following operations of:
(a) generating a random number and starting a game;
(b) determining a symbol to be rearranged on the display corresponding to the generated random number;
(c) variably displaying each of the plurality of symbol groups on the display;
(d) when at least a predetermined number of identical symbols are determined to be rearranged and a multiplication factor symbol representing a multiplication factor of an award to be provided is determined to be rearranged, extracting rearrangement pattern data corresponding to the number of the identical symbols from the memory;
(e) rearranging symbols based on the extracted rearrangement pattern data so that the multiplication factor symbol is rearranged last; and
(f) providing an award corresponding to the identical symbols of which at least the predetermined number and the multiplication factor symbol are rearranged.

4. A gaming machine comprising:
a display for variably displaying each of a plurality of symbol groups;
memory for storing rearrangement pattern data for symbol rearrangement; and
a controller executing the following operations of:
(a) generating a random number and starting a game;
(b) determining a symbol to be rearranged on the display corresponding to the generated random number;
(c) variably displaying each of the plurality of symbol groups on the display;
(d) when at least a predetermined number of identical symbols are determined to be rearranged and a multiplication factor symbol representing a multiplication factor of an award to be provided is determined to be rearranged, extracting rearrangement pattern data corresponding to the number of the identical symbols from the memory;
(e) after rearranging symbols other than the identical symbols, rearranging symbols based on the extracted rearrangement pattern data, and further rearranging symbols so that the multiplication factor symbol is rearranged last; and
(f) providing an award corresponding to the identical symbols of which at least the predetermined number and the multiplication factor symbol are rearranged.

5. A gaming machine comprising:
a display for displaying each block arranged in the form of a matrix for displaying a plurality of symbols;
an input device for allowing a player to start a game; and
a controller for rearranging each symbol in each block arranged in the form of a matrix displayed on the display upon input to the input device, wherein
the controller executes the following operations of:
(a) determining symbols to be rearranged in each of the plurality of blocks by way of input to the input device;
(b) when the number of identical symbols targeted for provision of an award are included among a plurality of symbols to be rearranged in all of the plurality of blocks, replacing the number of identical symbols, which are targeted for provision of an award, to be rearranged in each of the blocks with symbols to be rearranged in other blocks; and
(c) providing an award after rearranging the number of identical symbols targeted for the award in all of the plurality of blocks.
